(19) United States
(12) Patent Application Publication
(10) Pub. No.: US 2023/0349481 A1
(43) Pub. Date: Nov. 2, 2023

(54) DEVICE WITH A COMPONENT AND A VALVE HOUSING

(71) Applicant: Schaeffler Technologies AG & Co. KG, Herzogenaurach (DE)

(72) Inventors: Lukas Kuhn, Oberreichenbach (DE); Horst Hartmann, Aurachtal (DE)

(73) Assignee: Schaeffler Technologies AG & Co. KG, Herzogenaurach (DE)

(21) Appl. No.: 17/780,541

(22) PCT Filed: Oct. 28, 2020
(86) PCT No.: PCT/DE2020/100923

§ 371 Date: May 27, 2022

(30) Foreign Application Priority Data
Dec. 10, 2019 (DE) 10 2019 133 669.4

(51) Int. Cl. F16K 27/02; F16K 11/02

(52) U.S. Cl. CPC F16K 27/0263; F16K 11/02

(57) ABSTRACT

A device includes a component and a valve housing The valve housing is arranged in a hole in the component and is at least partially enclosed by the wall of the component The component includes a first channel having a channel port extending into the hole. The valve housing includes two first ports arranged adjacent to each other about a center axis of the valve housing and opened radially, in the direction of the center axis, into an interior of the valve housing. The valve housing included a bridge arranged circumferentially between the two first ports. The two first ports are partially defined by the bridge. At least one section of at least one first port is arranged radially opposite the channel port such that a radially first passage through which flow medium can pass is formed between the first channel and the interior of the housing. An outer width of the bridge determined at an outer lateral surface of the valve housing is less than an inner width of the channel port determined at the hole.

### CROSS-REFERENCE TO RELATED APPLICATIONS

This application is the U.S. National Phase of PCT Appln. No. PCT/DE2020/100923 filed Oct. 28, 2020, which claims priority to DE 102019133669.4 filed Dec. 10, 2019, the entire disclosures of which are incorporated by reference herein.

### BACKGROUND

Valves can have a valve body which also has inlet or outlet ports directed transversely to the valve axis, as described in DE 10 2015 211 599 A1. For such valves, directed assembly is often necessary so that the transversely directed ports of the valve body and those of the associated channels in the housing are connected in such a way that they are permeable with one another.

### SUMMARY

It is desirable to provide a device and a valve which can be assembled easily and inexpensively.

According to one exemplary embodiment of the disclosure, a device is provided with a component and a valve housing having the following features:
The valve housing sits in a hole in the component and is at least partially enclosed by a wall of the component. The component is, for example, a housing of a transmission or a hub of a rotating component. The component is made of steel or, for example, of an aluminum alloy.
The valve housing is provided with at least two first ports which are circumferentially adjacent to one another about an axially oriented center axis of the valve housing. The first ports are directed transversely, i.e., radially in the direction of the center axis.
The adjacent first ports are each defined by a common bridge of the valve housing arranged on a circumferential side between the first ports in each circumferential direction about the center axis. The first ports are thus defined on the circumferential side by a respective bridge and separated from one another by the respective bridge. The respective bridge may be made of the same material as the valve housing and may be formed integrally with the valve housing.
The component has at least one first channel with a first channel port. Flow media flow to or from the first port(s) via the respective first channel.
The first channel port and at least one section of at least one of the first ports lie radially opposite one another such that over the first channel opening and the first opening a radially first passage through which flow medium can pass is formed between the respective first channel and an interior of the valve.
A largest bridge width oriented on the circumferential side of the bridge between two of the ports is smaller than a largest channel port width of the first channel port measured on the circumferential side in the same circumferential direction.

Typically, the passage for flow medium through the valve is axial. This means that the flow medium flows into a front port of the valve and leaves the valve at the rear. The flow medium is, for example, oil, e.g., gear oil. However, there are also devices in which pressures of the flow medium or the direction of flow of the flow medium between a longitudinal and a transverse channel must be controlled. In this case, for example, the valve has a longitudinally oriented port and at least one transversely oriented port. Transverse is seen in the radial direction to the axially aligned center axis. The assembly of such valves in the device or component is relatively complicated because the transversely oriented port must be precisely aligned with respect to the transverse channel so that the flow medium can flow unimpeded through the port into the transverse channel or vice versa. The problem with this is that even slight inadvertent rotation of the valve about its own axis can create a circumferential side offset between the passage cross-sections of the port and the channel, thus creating the risk that insufficient flow medium can pass through.

Means would therefore have to be found to align the valve exactly in its position during assembly so that there is correspondence between the flow cross-sections of the transverse channel and the transversely oriented port in the valve. The effort required for such a position-oriented assembly is relatively high. An arrangement according to the disclosure avoids this effort.

The adjacent first ports are each defined by a common bridge in each circumferential direction about the center axis. At the same time, the largest bridge width oriented on the circumferential side of the bridge between two of the first ports is smaller than the smallest channel port width of the first channel port measured on the circumferential side in the same circumferential direction. Even if a valve is inserted into the component without directional assembly around the center axis, the channel port may not be completely covered if the bridge is in an unfavorable position relative to the channel port. This may not even be the case if one of the bridges is directly radially opposite the channel port. In any case, sufficient flow medium can pass through the first channel and port without the need to insert the valve oriented about its center axis into the bore of the component. This is particularly ensured if, as one embodiment of the disclosure provides, the width of the bridge does not exceed one third of the channel port.

In one embodiment of the disclosure, the valve housing fits snugly within the hole of the component, wherein at least two of the first ports are partially or completely closed by the component. The tight guidance of the valve housing in the component ensures that flow medium only flows into and out of the valve via the first ports provided for this purpose and that no leakage losses occur.

According to a further embodiment of the disclosure, the valve housing is provided with at least three first ports arranged on the circumferential side. The width of the bridges, as mentioned before, is also based on how wide the channel port is. As a result, the width of the bridges is limited. In the case where the valve housing is provided with only two of the first ports, it follows that each of the first ports, subject to twice a bridge width, must extend for nearly half of the circumference. However, this could also result in an unstable design of the valve housing. In this case, the upper portion of the valve housing and the lower portion of the valve housing would only be connected by two bridges. These are formed to be very narrow compared to the overall circumference of the valve housing. Since the valve housing may be made of sheet metal by cold forming, the cross-sections of the bridges may also be formed with a low sheet thickness. In the event that the valve has to be pressed into the component, for example, this could lead to unwanted deformation of the valve housing in the areas of the bridges during pressing. The method of manufacturing such valve housings often also provides for transverse punching of the first ports. This method requires a minimum cross-section of the bridges for tooling reasons and for dimensional stability. Therefore, one embodiment of the disclosure provides for more than two first ports, for example, at least three first ports. This increases the number of bridges and the bridge area between the upper and lower portions of the valve is more stable.

Based thereon, one embodiment of the disclosure provides that the valve housing is provided with at least three of the first ports and the associated bridges distributed with equal circumferential pitch to one another circumferentially of the valve housing. Thus, the valve housing is divided in the bridge area into several circumferential portions corresponding to the number N of the first ports plus the same number N of circumferential portions corresponding to the bridges. So in the case of N=3 first ports and N=3 bridges, this means a division into six circumferential portions. The circumferential pitch UT is a radian measure of a pitch circle describing the width of the first port at its narrowest point in the circumferential direction, and which lies on a full circle circumference line AU around the center axis where the narrowest point of the first port is located. Thus, the circumferential pitch is the circumferential width of the first port measured at its narrowest point between two bridges defining the first port.

The following applies: AU−((N×UT)+(N×ST) corresponds to the numerical value 0. AU is the full circle circumference AU of the valve housing at the narrowest point. N corresponds to the number of first ports in the valve housing and the same number N of defining bridges. ST stands for the width of the bridge in radian measure and is also measured on the full circle circumference AU like the circumferential pitch UT. The uniform distribution of the first ports on the circumference, the, at the same time, equal dimensions of the bridges among each other and, advantageously, the equal widths of the first ports in the circumferential direction guarantee the same flow cross-section at this passage from the component into the valve in any position of the valve housing to the first channel. The uniform distribution of the first ports and bridges on the circumferential side and thus the symmetry also facilitate the manufacture of such valve housings.

One embodiment of the disclosure provides at least one second port in the valve housing axially facing a second channel port of a second channel such that an axial second passage through which flow medium can pass is formed between the second channel and the interior of the valve housing.

The first ports are oriented to be transverse to the second port and are introduced into the valve housing made of sheet metal, e.g., by punching. The first ports extend in the axial direction at a radial distance from a center axis. The center axis of the respective first port runs in the radial direction perpendicular to the center axis. The valve housing can be produced easily and inexpensively.

A piston is guided via a piston casing in an axially movable manner in the valve housing and centered radially in the valve housing. This advantageously results in an essentially pressure-tight and at the same time axially movable guidance of the piston in the valve housing, in particular when the radial play with which the piston is centered radially in the housing is very small. Sliding surfaces, i.e., diameters of an inner cylindrical surface of the valve housing and an outer cylindrical surface of the piston, can be set very precisely when these components are drawn from sheet metal without machining. Sliding coatings on the surfaces of the components can be advantageous.

The piston is guided to be axially movable in the valve housing, from a closed position into an open position, against spring forces of a spring. In the closed position of the piston, the second port is closed by a piston base and the first ports are at least partially closed by the piston casing. In the open position, the piston base has lifted off a valve seat. At least one edge or a contour of the piston thereby exposes, analogously to a control edge, the first ports not pinned by the component or their portions not covered by the component, so that a connection through the valve that flow medium can pass is formed between the second port and at least one of the first ports. In this case, the open end of the valve housing axially opposite the second port is sealed off from the flow medium both in the closed position and in the open position by the piston, subject to a leakage gap between the pistons and the component caused by radial play.

It is conceivable that, already or still in the closed position, the first ports opposite the first channel port are only partially closed by the piston casing. This means that a slot-shaped through-opening of this first port, through which the flow medium can flow, is not covered by the piston casing and is not covered by the piston in the closed position and opens into the first channel in an installed state. The slot-shaped through-opening is defined, at least in the closed position, by a portion of the piston and an edge of the respective second port, which opens into the opening cross-section of the channel. The advantage of the disclosure is that immediately after the valve is opened, a passage through which the flow medium can flow is formed by the valve between the first port and the second port, or in the reverse direction of flow, and the pressure is quickly reduced. This has an advantageous effect on the design of the spring.

The same effect is achieved if an annular channel is formed between the piston and the valve housing, which is directly connected to the valve seat. The annular channel can be designed as desired through the design of the valve housing and the piston. The annular channel fills with the flow medium immediately after the piston lifts off the valve seat. The pressure of the flow medium is thereby transposed over a larger area of the piston.

The same effect is also achieved if the piston base and the piston casing are connected to one another by means of a transition portion formed on the piston. An annular channel is defined by the transition portion and by a portion of the valve housing opposite the transition portion, at least in the closed position.

Alternatively, a combination of both measures is also provided for. The annular channel is already open towards the at least one second port in the closed position of the piston at the slot-shaped through-opening.

From the measures mentioned above, it follows that the pressure that is necessary to open the valve is greater than the pressure that prevails in the valve when the piston has lifted from the valve seat. The advantage of such an arrangement is that values for the opening and closing pressures of the valve according to the disclosure can be set to be constant and reliable in the process and the pressure compensation takes place within a very short time.

The valve is provided with a sleeve-shaped valve housing which, on an upper portion, has a sleeve casing oriented concentrically to the center axis and an edge made of sheet metal that is oriented radially in the direction of the center axis and extends around the second port. The edge is optionally provided with a separate valve seat fastened to the edge or the valve seat is punched from sheet metal directly into the edge. Such a solution can be produced very inexpensively. There is no need for a costly machining of a valve seat. The upper portion is followed by the bridge portion with the first ports. Towards the end of the valve follows the lower portion to which the support element is attached.

One embodiment of the disclosure provides that the piston is sleeve-shaped with a hollow cylindrical piston casing and the piston base closing the piston on one side, wherein the spring is axially surrounded by the piston casing and supported axially inside the piston on the piston base. The piston may be made of sheet metal. The piston base is correspondingly thin-walled. Compared to solid pistons, there is thus more axial installation space available for the spring since the interior of the piston is also available as installation space for the spring. As a result, more options are available for the selection and design of the spring, which can also consist of several springs connected in parallel or in series.

A support element is inserted into a circumferential groove at an end of the valve housing facing away from the first port and is supported at least axially in the circumferential groove. The securing of the support element on the valve housing in a form-fitting manner prevents from the outset deformations between the valve housing and the support element that can be caused by a press fit. The accuracy of the valve seat is therefore guaranteed in every case. The circumferential groove in the valve housing, which is necessary for the form fit, can easily be introduced into the forming process during the production of the valve housing from sheet metal without additional machining expenditure.

In the context mentioned above, the disclosure provides a device for regulating pressures of a flow medium in a vehicle transmission. The device is formed from a portion of a transmission component, at least a first channel and a second channel, and the valve. In the portion of the transmission component, the first channel leads to the first port and at least two second ports open into the second channel.

### BRIEF DESCRIPTION OF THE DRAWINGS

The disclosure is described below using an exemplary embodiment and further embodiments of the disclosure of a valve. In this case, the valve is designed as a pressure compensation valve and is installed in a device for controlling pressures of a flow medium. In the figures:

FIG. 1—shows a device 1 in a highly simplified and not to scale sketch, which is shown in cross-section to a center axis 2 of an otherwise not further shown valve, extending perpendicularly into the image in this representation;

FIG. 2—shows the device 1 in a longitudinal section along the center axis 2 and the line II-II according to FIG. 1 for controlling pressures of a flow medium in a vehicle transmission with a valve 3 installed therein;

FIG. 3—shows the valve 3 inserted into the device 1 as an individual part in an overall view;

FIG. 4—shows a schematic representation of a valve housing 6 of the valve 3 shown in FIG. 3, showing the hole pattern and distribution of ports 7 and 25 on the valve housing 6;

FIG. 5—shows a schematic representation of another valve housing 33 as an alternative to the valve housing 6 shown in FIG. 4;

FIG. 6—shows a section of the device 1 with a partially cut component 4 and with a view through a channel port 5 of a transverse channel 19 formed in the component 4 to the valve housing 6;

FIG. 7—shows a section of the device 1 with the partially cut component 4 and with a view through the channel port 5 of the transverse channel 19 formed in the component 4 to the valve housing 6 in an installation position changed from that shown in FIG. 6;

FIG. 8—shows a section of the device 1 with the partially cut component 4 and with a view through the channel port 5 of the transverse channel 19 formed in the component 4 to the valve housing 6 in an installation position changed from that shown in FIG. 6;

FIG. 9—shows a section of a further exemplary embodiment of a device according to the disclosure with the partially cut component 4 and with a view through the channel port 5 of the transverse channel 19 formed in the component 4 to a valve housing 33.

### DETAILED DESCRIPTION

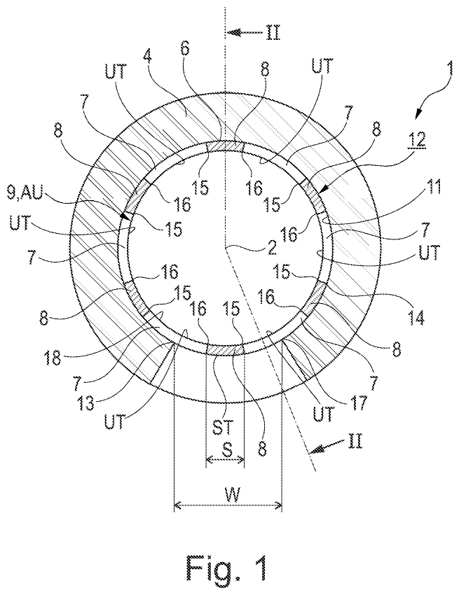

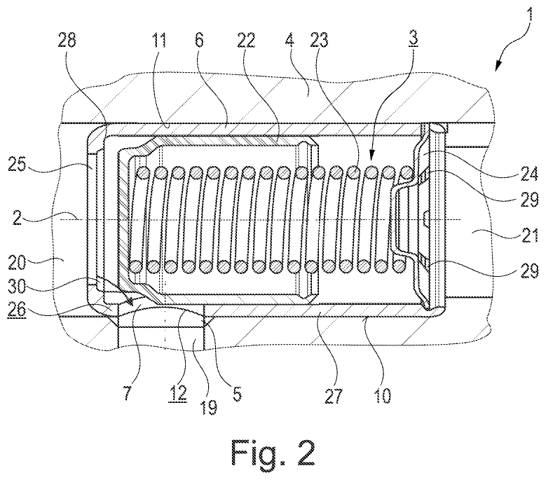

FIG. 1—A component 4 of A device 1 is provided with a channel port 5 (see FIG. 2). FIG. 1 shows a valve housing 6 in a sectional view through a bridge area 12. The valve housing 6 sits in a bore 11 of the component 4. A joint 14 defined by a press fit, alternatively a transition fit or a clearance fit, is formed between an outer lateral surface 10 of the valve housing 6 and an inner lateral surface of the bore 11 of the component 4. The valve housing 6 is provided with N=6 circumferentially distributed first ports 7 and N=6 circumferentially distributed bridges 8. A full circle 9 extending in the bridge area 12 to any axial height around a center axis 2 lies at the same time on a cylindrical inner lateral surface 18 of the valve housing 6. Accordingly, a full circle circumference AU of the full circle 9 in the nominal dimension corresponds to the inner circumference of the valve housing 6 in the bridge area 12. The first ports 7 have a same circumferential pitches UT between them, and the bridges 8 each have a same circumferential pitch ST between them.

The circumferential pitch UT is a radian measure, i.e., the length of a pitch circle lying on the full circle 9 with the full circle circumference AU. In the image, the respective pitch circle UT extends between limiting edges 15 and 16 of the first ports 7, which are at the same time limiting edges 15 and 16, respectively, of the respective bridge 8 and which each extend on the full circle 9 on the inner lateral surface 18 of the valve housing 6, as viewed in a counterclockwise direction. In this regard, it is not excluded that these limiting edges 15 and 16 are also provided with a chamfer. The limiting edges 15 and 16 define the respective first port 7 at the narrowest point in the circumferential direction, which in this case is at the height of the inner lateral surface 18.

The numerical value 0 is equal to a difference resulting from the circumference AU of the full circle 9 and a sum of ((N×UT)+(N×ST). This sum corresponds to the circumference AU of the full circle 9 of the valve housing 6, which runs along the first ports 7 where they have their narrowest point in the circumferential direction. N is the number of first ports 7 in the valve housing 6 and also the number of defining bridges 8. ST describes a width of the respective bridge 8 in radian measure between the limiting edges 15 and 16 as viewed in a clockwise direction, which is measured on the circumference AU.

FIG. 2—The device 1 consists of the component 4, a valve 3, a first channel 19, a second channel 20 and a third channel 21. The valve 3 comprises the valve housing 6, a piston 22, a spring 23 and a support element 24. The spring 23 is axially clamped between the piston 22 and the support element 24. The support element 24 is supported or retained on the valve housing 6. The piston 22 is guided axially in a displaceable manner along a valve axis on the inner lateral surface 18 of the valve housing 6. The valve axis 7 corresponds to the center axis 2. The valve housing 6 is provided with several first ports 7 separated from one another on a circumferential side by bridges 8 not visible in this illustration (see bridges 8 in FIG. 1), of which, however, only one first port 7 is visible in the illustration due to the longitudinal section. The first ports 7 are aligned transversely to the center axis 2. In addition, the valve housing 6 has a second port 25 which is penetrated axially by the center axis 2. The valve housing 6 can be divided into an upper portion 26, the bridge area 12 (see sectional drawing of FIG. 1) and a lower portion 27. The upper portion 26 is provided with the second port 25 and has a valve seat 28 against which the piston 22 abuts in a sealing manner in its closed position. However, the piston 22 is shown in an open position in FIG. 2. The bridge area 12 comprises the first ports 7 and the bridges 8. The lower portion 27 of the valve housing 6 is used to guide the piston 22 and is used as an anchorage for the support element 24. In addition, the valve 3 has through-openings 29 in the support element 24 at the rear there.

The channel port 5 of the first channel 19 is radially opposite one or two of the first ports 7. The second channel 20 opens into the second port 25 and continues axially in the bore 11. The valve housing 6 is pressed into the bore 11 via the outer lateral surface 10. The rear of the valve 3 is open at the through-openings 29 into the third channel 21. In the open position of the piston 22 shown in FIG. 2, the flow medium 30 symbolized by an arrow can flow from the second channel 20 through the second port 25, through the valve 3 and from the first ports 7 into the first channel 19.

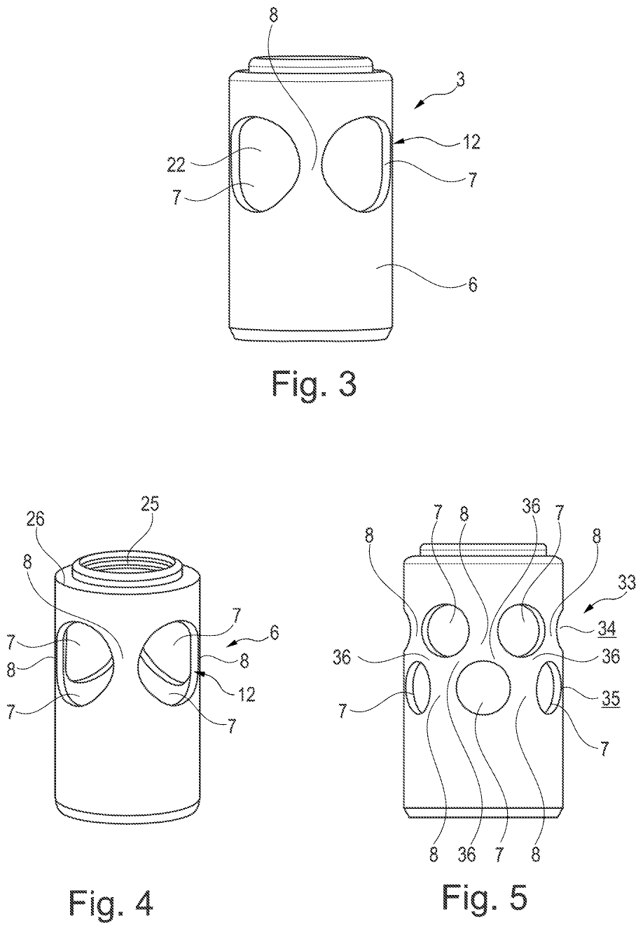

FIGS. 3 and 4—In the bridge area 12, the valve housing 6 of the valve 3 has several first ports 7 adjacent to one another on the circumferential side, each of which is defined on the circumferential side by a bridge 8. A part of the piston 22 is visible through the respective ports 7. Also, the second port 25 is visible at the beginning of the upper portion 26 of the valve housing 6.

FIG. 5-FIG. 5 shows an alternative valve housing 33 with multiple first ports 7 adjacent to one another on the circumferential side in an upper row 34 and separated from one another by bridges 8, and with a lower row 35 of further first ports 7 axially offset therefrom, which are formed together in the bridge area 12. The first ports 7 of the lower row 35 are separated from one another on the circumferential side by bridges 8 and from the first ports 7 of the upper row 34 by further bridges 36.

FIG. 6—This figure represents a view through the first channel port 5 surrounded by the first component 4 to an opening cross-section 31 of a first port 7 of the valve housing 6 as well as to a further opening cross-section 32 of a further first port 7. The valve housing 6 is rotated about its own axis relative to the channel port 5 in such a manner that a bridge 8 extending between these two first ports 7 covers part of the opening cross-section of the channel port 5 in the axial direction and circumferential direction. The largest bridge width S oriented on the circumferential side of the bridge 8 between the two first ports 7 is smaller than the largest channel port width W of the channel port 5 measured on the circumferential side in the same circumferential direction (see FIG. 1). Flow medium can therefore flow into the first channel 19 through the opening cross-sections 31 and 32. The rest of the respective port 7 is covered by the component 4.

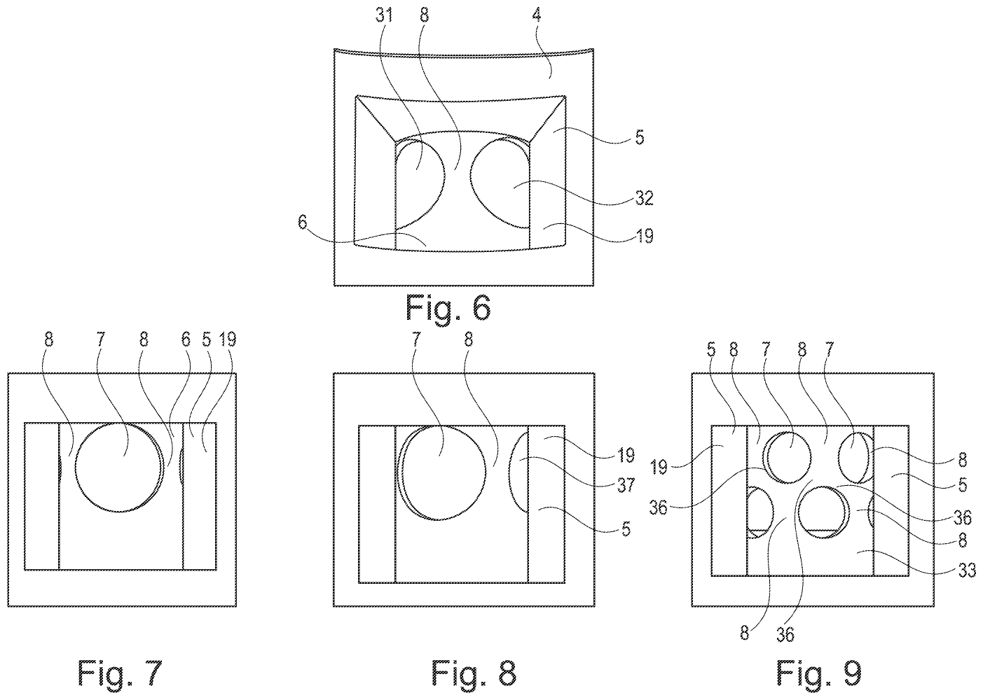

FIG. 7—Compared to the arrangement shown in FIG. 6, the valve 3 is rotated around its own axis in such a manner that the opening cross-section of one of the first ports 7 lies completely opposite the channel port 5 and the channel port 5 is covered by a bridge 8 on the left and right sides respectively.

FIG. 8—The valve housing 6 is rotated about its own axis relative to the channel port 5 in such a manner that the opening cross-section of a first port 7 lies opposite the channel port 5 in a completely free manner and only a gap 37 remains as a free flow cross-section from a further first port 7. A bridge 8 covers part of the channel port 5.

FIG. 9—Several of the first ports 7 of the valve housing 33 shown in FIG. 5 lie opposite to the channel port 5 in a permeable manner, and several of the bridges 8 and 36 cover portions of the flow cross-section of the channel port 5.

### LIST OF REFERENCE SYMBOLS

1 Device
2 Center axis
3 Valve
4 Component
5 Channel port
6 Valve housing
7 First port
8 Bridge
9 Full circle
10 Outer lateral surface
11 Bore
12 Bridge area
13 Limiting edge of the channel port
14 Joint
15 Limiting edge of the first port or bridge
16 Limiting edge of the first port or bridge
17 Limiting edge of the channel port
18 Inner lateral surface
19 First channel
20 Second channel
21 Third channel
22 Piston
23 Spring
24 Support element
25 Second port
26 Upper portion
27 Lower portion
28 Valve seat
29 Through-openings
30 Flow medium
31 Opening cross-section
32 Opening cross-section
33 Valve housing
34 Upper row of first ports
35 Lower row of first ports
36 Bridge
37 Gap

1. A device, comprising:
a component including a wall defining a hole, the component including a first channel having a channel port extending throughout the wall into the hole;
a valve housing arranged in the hole and at least partially enclosed by the wall,
the valve housing including two first ports arranged adjacent to one another about a center axis of the valve housing radially and opened, radially relative to the center axis, into an interior of the valve housing,
the valve housing including a bridge arranged circumferentially between the two first ports, the two first ports each being partially defined by the bridge, and
at least one section of at least one of the first ports being arranged radially opposite the channel port such that a radially first passage through which flow medium can pass is formed between the first channel and the interior of the valve housing via the channel opening and the at least one first,
wherein an outer width, determined at a joint between the valve housing and the hole, of the bridge is less than an inner width, determined at the joint, of the channel port.

2. The device according to claim 1, wherein the component includes a second channel arranged transverse to the first channel, and the valve housing includes at least one second port axially facing the second channel and opened, axially relative to the center axis, into the interior of the valve housing, wherein an axial second passage through which flow medium can pass is formed between the second channel and the interior of the valve housing via the at least one second port.

3. The device according to claim 1, wherein the valve housing abuts the hole circumferentially about the center axis, wherein at least one of the first ports is partially or completely closed by the component.

4. The device according to claim 1, wherein the outer width of the bridge is less than or equal to one third of the inner width of the channel port.

5. The device according to claim 1, wherein the valve housing includes at least three circumferentially arranged first ports.

6. The device according to claim 1, wherein the first ports are arranged circumferentially and axially offset from one another.

7. The device according to claim 1, wherein the valve housing includes at least three of the first ports uniformly distributed relative to each other circumferentially about the center axis and at least three bridges uniformly distributed relative to each other circumferentially about the center axis, wherein each of the first ports has a same inner width determined at an inner lateral surface of the valve housing, and each of the bridges has a same inner width determined at the inner lateral surface of the valve housing, and wherein a sum of the inner widths of the first ports and the inner widths of the bridges equals a circumference of the inner lateral surface.

8. The device according to claim 1, wherein the bridge partially covers the channel port.

9. The device according to claim 1, wherein at least one section of each of the two first ports are arranged radially opposite the channel port such that the radially first passage through which flow medium can pass is formed between the channel and the interior of the valve housing via the channel port and the two first ports.

10. The device according to claim 2, further comprising a piston axially moveable in the valve housing to an open position, in the open position, a passage through which flow medium can pass is formed between the second channel and the interior of the valve housing via the second port.

11. A device, comprising:
a component including a wall defining a hole extending circumferentially about an axis, the component including a first channel having a channel port extending radially relative to the axis through the wall into the hole;
a valve housing being disposed in the hole and defining an interior extending circumferentially about the axis;
the valve housing including two first ports spaced from each other circumferentially about the axis and extending radially relative to the axis into the interior, the first ports being axially aligned with each other relative to the axis; and
the valve housing including a bridge disposed circumferentially between two first ports, the bridge extending circumferentially about the axis to each first port;
wherein the first channel is in fluid communication with the interior of the valve housing via the channel port and at least one of the first ports;
wherein an outer width, determined at a joint between the valve housing and the hole, of the bridge is less than an inner width, determined at the joint, of the channel port determined.

12. The valve of claim 11, wherein the component includes a second channel arranged transverse to the first channel, and the valve housing includes at least one second port axially facing the second channel and opened axially relative to the axis into the interior of the valve housing.

13. The valve of claim 12, further comprising a piston housed in the valve housing, the piston being axially moveable in the valve housing to an open position spaced from the at least one second port, wherein, in the open position, the second channel is in fluid communication with the interior of the valve housing via the at least one second port.

14. The valve of claim 13, wherein the piston is axially moveable in the housing to a closed position abutting the at least one second port, wherein, in the closed position, the piston prevents fluid communication between the interior of the valve housing and the second channel via the at least one second port.

15. The valve of claim 11, wherein the bridge partially covers the channel port.

16. The valve of claim 11, wherein the component includes a further first channel having a further channel port, and the valve housing includes a further first port, the further first channel being in fluid communication with the interior of the valve housing via the further channel port and the further first port, and wherein the further first port is axially and circumferentially offset from to the two first ports relative to the axis.

17. The valve of claim 16, wherein the valve housing includes a further bridge disposed axially between the further first port and the two first ports, the further bridge extending from the further first port to the two first ports.

18. A valve, comprising:
a valve housing configured to be received in a hole of a component and defining an interior extending circumferentially about an axis;
the valve housing including two first ports spaced from each other circumferentially about the axis and extending radially relative to the axis into the interior; and
the valve housing including a bridge disposed circumferentially between two first ports, the bridge extending circumferentially about the axis to each first port;
wherein an outer width, determined at a joint between the valve housing and the hole, of the bridge is configured to be less than an inner width, determined at the joint, of a channel port for the component.

19. The valve of claim 18, wherein the two first ports are axially aligned with each other relative to the axis.

20. The valve of claim 18, wherein the valve housing includes a further first port and a further bridge, the further first port being axially and circumferentially offset from to the two first ports relative to the axis, and the further bridge extending axially from the further first port to the two first ports.
